(19) United States
(12) Patent Application Publication
(10) Pub. No.: US 2024/0355603 A1
(43) Pub. Date: Oct. 24, 2024

(54) Determination of Ion Control for Detector Life Time and Provision for Notice To End User

(71) Applicant: DH Technologies Development Pte. Ltd., Singapore (SG)

(72) Inventors: Anjali CHELUR, Bradford West Gwillimbury (CA); Stephen TATE, Barrie (CA)

(21) Appl. No.: 18/693,343

(22) PCT Filed: Sep. 21, 2022
(86) PCT No.: PCT/IB2022/058923

§ 371 Date: Mar. 19, 2024

Related U.S. Application Data
(60) Provisional application No. 63/246,873, filed on Sep. 22, 2021.

(51) Int. Cl. H01J 49/00

(52) U.S. Cl. CPC H01J 49/0031; H01J 49/0036

(57) ABSTRACT

In one aspect, a method of operating a mass spectrometer is disclosed, which comprises ionizing a sample to generate a plurality of ions, and introducing at least a portion of the ions into an inlet orifice of the mass spectrometer. At least a portion of the ions and/or fragments thereof is detected by a downstream detector to generate a plurality of ion detection events, and the ion detection events are monitored to determine an ion count. The ion count is compared with a reference level to determine whether the detected level exceeds the reference level.

### BACKGROUND

The present disclosure is generally directed to mass spectrometers and more particularly to methods and systems for operating a mass spectrometer that can help with extending the useful lifetime of the spectrometer's ion detector.

Mass spectrometry (MS) is an analytical technique for determining the structure of test chemical substances with both qualitative and quantitative applications. MS can be useful for identifying unknown compounds, determining the atomic composition of a molecule, determining the structure of a compound by observing its fragmentation, and quantifying the amount of a particular chemical compound in a mixed sample. Mass spectrometers detect chemical entities as ions such that a conversion of the analytes to charged ions must occur during the sample introduction. The ions are detected by a downstream detector, which generates ion detection signals, which can be analyzed to generate a mass spectrum of the ions.

### SUMMARY

In one aspect, a method of operating a mass spectrometer is disclosed, which comprises ionizing a sample to generate a plurality of ions, and introducing at least a portion of the ions into an inlet orifice of the mass spectrometer. At least a portion of the ions and/or fragments thereof is detected by a downstream ion detector to generate a plurality of ion detection events, and the ion detection events are monitored to determine a count of ions detected by the detector, i.e., the number of ions detected by the detector over a temporal period (e.g., over a sample run). The ion count can be compared with a reference level to determine whether the ion count exceeds the reference level, which is herein referred to also as a threshold.

In some embodiments, a notification can be generated when the determined ion count exceeds the reference level. In some embodiments, the notification can include a recommendation for the preparation of one or more subsequent samples to be introduced into the mass spectrometer. For example, the notification may recommend that the subsequent sample(s) be diluted.

In general, the reference level is set so as to inhibit, and preferably prevent, rapid aging of the ion detector and hence enhance its useful lifetime. By way of example, the reference level can be determined based on previously-obtained calibration data. In some cases, the reference level can be determined based on historical data regarding detectors of similar type and their respective useful lifetime. In some embodiments, the reference level can be set based on the type of the ion detector. Any ion detector known in the art or subsequently developed can be employed in the practice of the present teachings. An example of a suitable ion detector can include, without limitation, a Microchannel Plates detector (MCP).

In some embodiments, in addition to or instead of issuing a notification in response to an ion count that exceeds a predefined reference level, a sample queue for the introduction of a plurality of samples into the mass spectrometer can be paused, thus stopping data acquisition by the mass spectrometer. In some such embodiments, the operator may restart the sample queue, for example, subsequent to adjusting the concentration of samples to be introduced into the mass spectrometer.

In a related aspect, a mass spectrometer is disclosed, which comprises an inlet orifice for receiving a plurality of ions, and a downstream ion detector for detecting at least a portion of the received ions or ion fragments thereof to generate a plurality of ion detection signals. In some embodiments, the mass spectrometer can further include an analog-to-digital converter (ADC) that receives the ion detection signals from the ion detector and digitizes the detector's signals so as to generate a plurality of digitized signals (e.g., a plurality of pulses each of which corresponds to an ion detection event). A logic module can receive the digitized signals and compute an ion count (e.g., the number of detected ions during a temporal period (e.g., during a sample run)). The logic unit can further compare the computed ion count with a predefined threshold to determine whether the computed ion count exceeds the predefined threshold.

If the logic unit determines that the computed ion count exceeds the predefined threshold, it can provide a notification signal to a user interface unit of the mass spectrometer to generate a notification indicating that the ion count (e.g., the number of ions detected by the ion detector over a temporal period) is above an acceptable threshold (herein also referred to as an acceptable reference level). In some embodiments, the notification can include a recommendation for the preparation of subsequent samples to be introduced into the mass spectrometer, e.g., for diluting the subsequent samples.

In addition or alternatively, the logic unit can send a signal to a controller indicative of the high ion count. In response, the controller can provide a control signal for pausing the sample queue and hence stop the introduction of subsequent samples into the mass spectrometer, as discussed in more detail below. In some such embodiments, a user can restart the queue after its pause, e.g., after diluting the samples.

By way of example, in some embodiments, the logic module can be implemented in software and/or firmware.

Further understanding of various aspects of the present teachings can be obtained by reference to the following detailed description in conjunction with the associated drawings, which are described briefly below.

### BRIEF DESCRIPTION OF THE DRAWINGS

FIG. 1 is a flow chart depicting various steps of an embodiment of a method according to the present teachings for performing mass spectrometry,

FIG. 2A schematically depicts an embodiment of a mass spectrometer according to the present teachings,

FIG. 2B schematically depicts various modules of a controller according to an embodiment of the present teachings, and

FIG. 2C schematically depicts an example of an implementation of the logic unit depicted in FIG. 2A.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

Ion detectors employed in mass spectrometers have a finite lifetime. The ion detection efficiency of an ion detector decreases as the total number of ion strikes on the detector increases. Based on the detector's design, this can lead to a rapid aging of the ion detector, especially when using highly sensitive data acquisition modes in which a large number of ions are generated and detected. It should be understood that the present teachings are not limited to any particular data acquisition mode, but rather can be employed in a variety of data acquisition modes.

Thus, there is a need for methods and systems that can extend the useful lifetime of ion detectors that are employed in mass spectrometers.

As discussed below, in some embodiments, the methods and systems according to the present teachings generate a notification in response to the detection of an ion count that is at an unacceptably high level (e.g., an ion count exceeding a reference level) to warn a user of the mass spectrometer that the ion count is above an acceptable level (herein also referred to as a reference level).

Embodiments of the present teachings disclose methods and systems for performing mass spectrometry in which a count of ions detected by an ion detector of a mass spectrometer can be monitored and can be compared with a reference level, e.g., a level associated with a recommended loaded sample. In some embodiments, if the ion count exceeds the reference level, a notification will be reported to the end user. In some embodiments, by determining the ion count from a recommended load and building a calibration table, the ion count can be calibrated against the expected level for the sample loaded into the mass spectrometer.

If the ion count (i.e., the number of detected ions over a temporal period (e.g., a sample run) that is monitored were to exceed that of the recommendation, a notification to the user can be generated, and/or the sample queue for introduction of subsequent samples into the mass spectrometer can be paused.

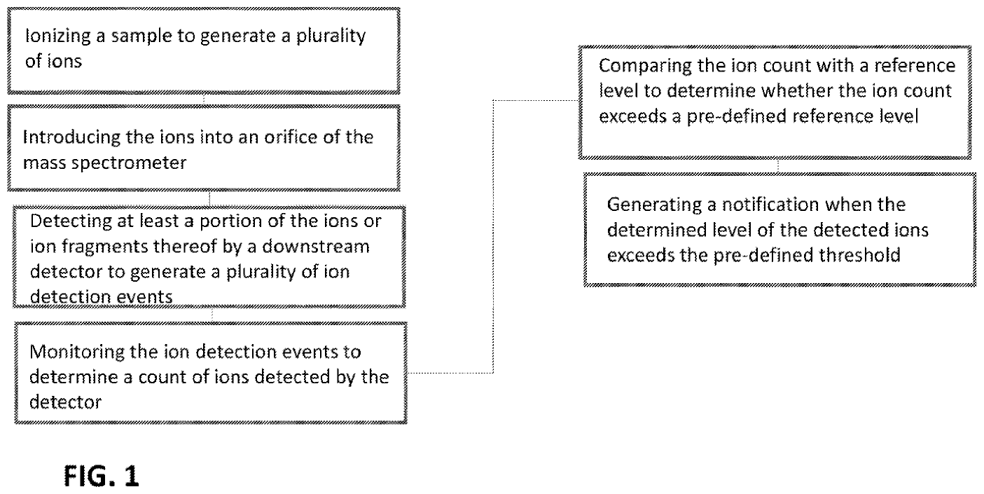

FIG. 1 is a flow chart illustrating various steps of a method for operating a mass spectrometer, which includes ionizing a sample to generate a plurality of precursor ions, and introducing the precursor ions into an inlet orifice of a mass spectrometer. A portion of the precursor ions and/or fragments thereof can be detected by a downstream detector to generate a plurality of ion detection events (herein referred to also as an ion detection signals). The ion detection events can be monitored to determine a count of ions being detected by the ion detector (e.g., the number of ions being detected over a temporal period, such as, during a sample run).

With continued reference to the flow chart of FIG. 1, the count of the detected ions can be compared with a reference level to determine whether the ion count exceeds the reference level. In some embodiments, a notification can be generated when the determined count of the detected ions exceeds the reference level. In some embodiments, the notification can include a recommendation to a user for the preparation of subsequent samples to be introduced into the mass spectrometer. For example, the notification may recommend a dilution of the subsequent samples so as to ensure that the ion count will remain within an acceptable range.

In addition to or instead of generating a notification, in some embodiments, the data acquisition by the mass spectrometer can be paused when the ion count exceeds the reference level.

In general, the reference level can be set to inhibit rapid aging of the ion detector, thereby enhancing its useful lifetime. In some embodiments, the reference level can be determined, e.g., based on the previously-obtained calibration data. In some embodiments, a calibration table can be constructed that provides reference levels for a plurality of different sample loadings. In some embodiments, the reference levels can be determined based on historical data regarding the useful lifetime of an ion detector together with the total count of ions detected by that detector over its useful lifetime.

In some embodiments, the number of ions detected by the ion detector over a temporal period is maintained at a level below about 1.3e9 ion counts per hour to inhibit rapid aging of the ion detector. This value has been determined based on the detector response generated by 24/7 continuous injection of 500 ng K562 for 30 days on a hybrid quadrupole/time-of-flight (QTOF) mass spectrometer. In general, the threshold level for the number of the detected ions can be set, e.g., based on the type of the ion detector and/or a particular ion detection modality. In embodiments, once the threshold is set, an analyte load can be selected such that the rate at which ions are incident on the detector remains at or below the threshold without loss of sensitivity.

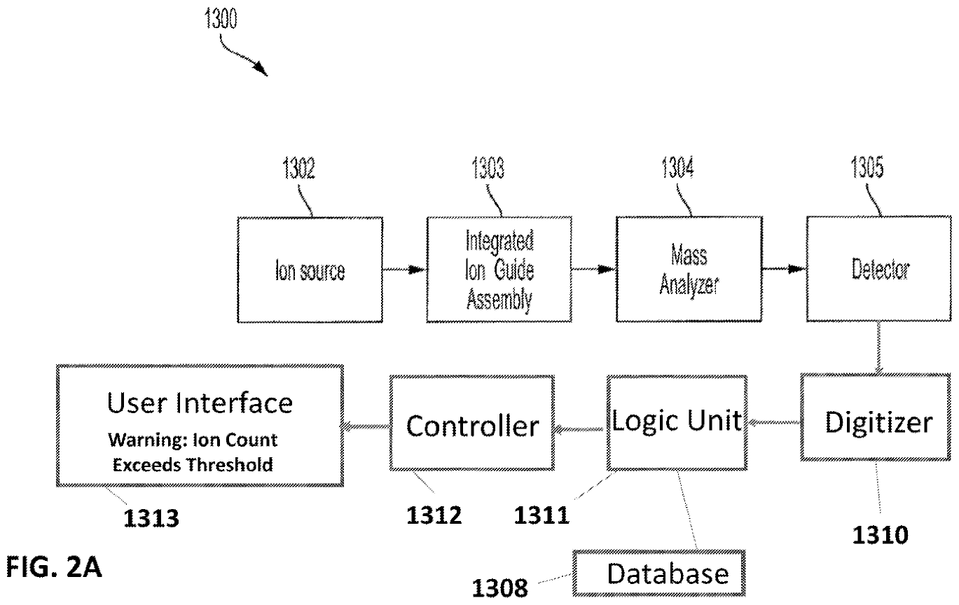

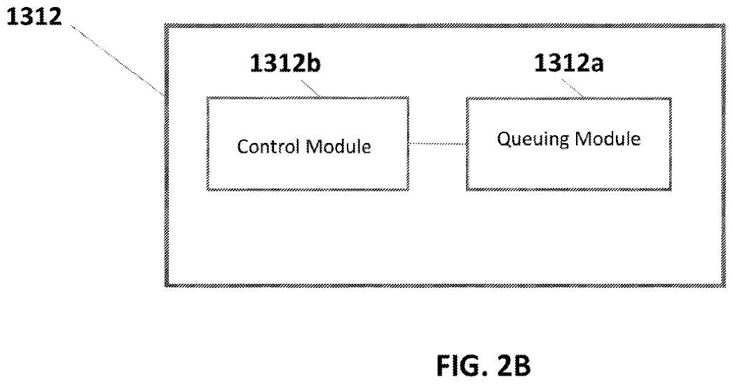

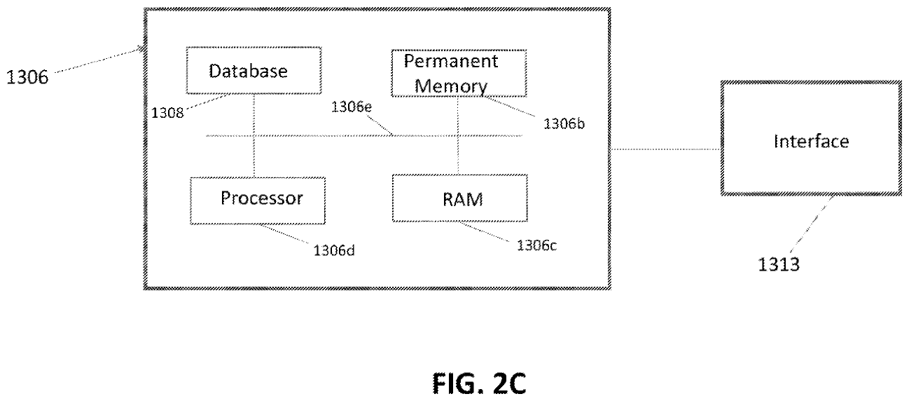

The present teachings can be incorporated in a variety of different types of mass spectrometers to enhance the useful lifetime of their ion detectors. By way of example, FIG. 2A schematically depicts a mass spectrometer 1300 that includes an ion source 1302 for receiving a sample and ionizing at least a portion of the sample so as to generate a plurality of ions. The ion source can be separated from the downstream section of the mass spectrometer by a curtain chamber (not shown). In some embodiments, the mass spectrometer can include an upstream assembly 1303 including an orifice plate, one or more ion guides, for example, for focusing the ions to form a narrow ion beam for transmission to the downstream components of the mass spectrometer.

By way of example, such ion guides can include a plurality of rods arranged in a multipole configuration, e.g., a quadrupole configuration, to which RF voltage(s) can be applied. The ions passing through the ion guide can be focused using a combination of gas dynamics and radio frequency fields.

The illustrated mass spectrometer further includes at least one mass analyzer 1304 that receives the ion beam and allows the passage of ions having an m/z ratio of interest or an m/z ratio within a target range, therethrough. In some embodiments, such a mass analyzer 1304 can be implemented using a plurality of rods that are arranged according to a multipole configuration, e.g., a quadrupole configuration. The application of RF and resolving DC voltages to these rods can allow only the ions having desired m/z ratios to pass through the mass analyzer. The ions passing through the mass analyzer can be received by a downstream ion detector 1305, which can generate ion detection signals in response to the detection of ions incident thereon.

In some embodiments, rather than a single mass analyzer, the mass spectrometer can include multiple mass analyzers. By way of example, the mass spectrometer can include two mass analyzers that are separated from one another by an ion fragmentation module (not shown in the figure), such as an electron capture dissociation (EAD) device or a collision cell in which ions can undergo collisional fragmentation. Without any loss of generality and only for the ease of description, in the following discussion, it is assumed that the ion fragmentation module is a collision cell in which ions can undergo collisional fragmentation. It should, however, be understood that a variety of different ion fragmentation devices and modalities can be employed in the practice of the present teachings.

In some embodiments, the collision cell can include a pressurized chamber (e.g., a chamber containing nitrogen, argon, or helium) maintained at a pressure in a range of, e.g., about 1 mTorr to about 10 mTorr, to cause collisional fragmentation of at least a portion of the ions so as to generate a plurality of product ions.

The product ions generated in the collision cell, or at least a portion thereof, can be received by the mass analyzer (e.g., a time-of-flight (ToF) mass analyzer) that is positioned downstream of the collision cell and those product ions that pass through the second mass analyzer can be detected by a downstream ion detector 1305, which can generate ion detection signals in response to the detection of ions incident thereon.

In some embodiments, the mass spectrometer can be operated in the SWATH® data acquisition mode in which MS/MS spectra of a plurality of precursor ions across a chromatic retention window are concurrently collected and analyzed. In such an embodiment, the first mass analyzer 1304 can be configured to provide an ion transmission window to allow the passage of precursor ions having m/z ratios within an entire range of retention time of the LC column.

As noted above, any ion detector known in the art or subsequently developed for detecting ions in a mass spectrometric system can be employed in the practice of the present teachings.

With continued reference to FIG. 2A, in this embodiment, the mass spectrometer includes a digitizer 1310 that has, among other elements, an analog-to-digital converter (ADC) configured to receive the ion detection signals generated by the ion detector and digitize those ion detection signals to generate a plurality of digitized signals (e.g., a plurality of pulses each corresponding to an ion detection event).

In this embodiment, the digitized signals can be received by a logic unit (e.g., a software module of the mass spectrometer) 1311 that is configured to count the digitized ion detection signals, e.g., over a temporal period (e.g., over a sample run), to generate an ion count, and compare the ion count with a predefined reference level (threshold). When such a comparison indicates that the ion count exceeds the threshold, the logic unit 1311 can generate one or more notification signals that are received by a controller 1312.

In response to the receipt of the signal(s) generated by the logic unit 1311, the controller 1312 can generate one or more control signals. For example, the controller 1312 can generate a control signal for transmission to a user interface 1313 of the mass spectrometer to cause the user interface to display a notification, such as that depicted in FIG. 2A, that is indicative of the ion count exceeding the predefined threshold.

In some embodiments, in addition to a notification, the user interface 1313 can present a recommendation to the user for the preparation of one or more subsequent samples to be introduced into the mass spectrometer so as to reduce the ion count, preferably below the predefined threshold, during subsequent sample runs. By way of example, the notification may recommend that the subsequent samples in queue for introduction into the mass spectrometer be diluted.

Alternatively or in addition, the controller 1312 can pause the sample queue to stop the introduction of a plurality of samples into the mass spectrometer. By way of example, with reference to FIG. 2B, in some embodiments, the controller 1312 can include a queuing module 1312a for generating a sample queue for introduction of a plurality of samples into the mass spectrometer. In such embodiments, the controller 1312 can include a control module 1312b that can receive a notification signal from the logic unit 1311 indicative of an ion count exceeding a threshold. The control module can in turn provide a signal to the queuing module to pause the sample queue, thereby stopping data acquisition.

In other embodiments, the queuing module can be implemented in a module of the mass spectrometer other than the controller and the controller can be in communication therewith for providing control signals thereto.

In some embodiments, the user can restart the sample queue by employing the user interface 1313 to provide a signal to the controller for re-initiating the data acquisition.

In some embodiments, the information regarding the predefined threshold can be stored in a configurational file on the logic unit 1311. Further, in some such embodiments, one or more ion counts, if any, exceeding the predefined threshold, and the timing of such events, can be stored in a log file on the logic unit 1311. In some embodiments, the logic unit 1311 can be in communication with a database 1308 for receiving information from and transmitting information to the database. By way of example, in response to the detection of an ion count that exceeds a reference level, the logic unit can store information regarding the ion count, the sample under study, and the time of the data acquisition associated with the unacceptably high ion count in the database 1308. By way of example, such information can be utilized to help provide a reference for the preparation of future samples (e.g., the concentration of future samples) for mass analysis. While in some embodiments the database 1308 is incorporated in the logic unit 1311, in other embodiments it can be implemented separately from the logic unit 1311.

It should, however, be understood that the present teachings are not limited to any particular MS data acquisition mode, and a variety of different data acquisition modes, such as SWATH®, MRM (multiple reaction monitoring) mode, can be employed.

By way of illustration, FIG. 2C schematically depicts an example of implementation 1306 of the logic unit 1311, which includes a permanent memory module 1306b for storing instructions, for example, for processing the ion detection signals received from the digitizer 1310, and a random access memory (RAM) module 1306c that can receive the instructions from the permanent memory 1306b during runtime for execution. A processor 1306d communicates with the memory modules and other components of the logic unit via a communication bus 1306e for controlling those components and causing the execution of the instructions.

The controller can also be implemented in software and/or firmware in a manner known in the art as informed by the present teachings. For example, the controller can be implemented as part of a software package for operating the mass spectrometer.

It should be understood that the implementation of the present teachings for enhancing the life time of an ion detector of a mass spectrometer is not limited to a particular implementation of the mass spectrometer or a particular data acquisition mode, but can be used in any mass spectrometer and using any data acquisition mode to enhance the life time of the spectrometer's ion detector.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill in the art will appreciate that various changes can be made to the above embodiments without departing from the scope of the present teachings.

What is claimed is:

1. A method of operating a mass spectrometer, comprising:
ionizing a sample to generate a plurality of ions,
introducing the ions into an orifice of the mass spectrometer,
detecting at least a portion of said ions or ion fragments thereof by a downstream ion detector to generate a plurality of ion detection events,
monitoring said ion detection events to determine a count of ions detected by the detector over a temporal period,
comparing said ion count with a reference level to determine whether the ion count exceeds said reference level, and
generating at least one of a notification and a control signal when the ion count exceeds said reference level.

2. The method of claim 1, wherein said reference level is set based on a type of the ion detector.

3. The method of claim 1, wherein said ion detector comprises an MCP detector.

4. The method of claim 1, wherein said notification includes a recommendation for preparation of one or more subsequent samples to be introduced into the mass spectrometer.

5. The method of claim 4, wherein said recommendation comprises recommending a reduction in a concentration of one or more subsequent samples to be introduced into the mass spectrometer.

6. The method of claim 1, further comprising pausing a sample queue for introduction of samples into the mass spectrometer when said ion count exceeds said reference level.

7. The method of claim 1, wherein said reference level is determined based on previously-obtained calibration data.

8. The method of claim 7, further comprising generating said calibration data by monitoring ion detection events for different samples.

9. The method of claim 1, wherein said reference level is about 1.3e9 per hour.

10. A mass spectrometer, comprising:
an orifice for receiving a plurality of ions,
a downstream ion detector for detecting at least a portion of said received ions or ion fragments thereof by a downstream detector to generate a plurality of ion detection signals,
a digitizer in communication with the ion detector to receive said ion detection signals and to digitize the received signals to generate a plurality of digitized signals,
a logic unit in communication with said digitizer to receive said digitized signals and compute an ion count based on said digitized signals, said logic unit further being configured for comparing said ion count with a reference level and generating a notification signal when said ion count exceeds the reference level, and
a controller in communication with said logic unit to receive said notification signal from the logic unit and generate at least one control signal.

11. The mass spectrometer of claim 10, further comprising a user interface in communication with said controller for receiving said at least one control signal and presenting a user notification indicating that the ion count exceeds said reference level.

12. The mass spectrometer of claim 10, wherein said user notification further provides a recommendation for preparation of subsequent samples for introduction into the mass spectrometer.

13. The mass spectrometer of claim 10, wherein said at least one control signal comprises a signal for pausing a sample queue for introduction of samples into the mass spectrometer.

14. The mass spectrometer of claim 10, wherein said ion detector comprises an MCP detector.

15. The mass spectrometer of claim 10, wherein said reference level is about 1.3e9 per hour.
